(19) United States
(12) Patent Application Publication
(10) Pub. No.: US 2009/0232625 A1
(43) Pub. Date: Sep. 17, 2009

(54) MOTION COMPENSATION SYSTEM

(76) Inventors: Benjamin M. Almeda, JR., Pearland, TX (US); Patrick Almeda, Pearland, TX (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/211,024

(22) Filed: Sep. 15, 2008

Related U.S. Application Data
(60) Provisional application No. 60/993,759, filed on Sep. 14, 2007.

(51) Int. Cl. B66C 23/53; B66D 1/48; B66C 13/18; B63B 27/10

(52) U.S. Cl. 414/139.6; 212/308

(57) ABSTRACT

A heave or motion compensation system (100) is employed on the crane (20) to compensate for the heave being experienced by a ship (22) on which the crane is mounted. The heave compensation system includes a motion reference unit (102) mounted on a distal end portion of crane arm (36) to measure the movement (acceleration) thereat. This information is transmitted to a programmable logic control processor (104) to control the operation of a winch (50) carried by the crane thereby to pay out or reel in the load line (32) of the crane. The distal end of the load line is connectable to a load being lowered or lifted by the crane.

### CROSS-REFERENCE TO RELATED APPLICATION

The present application claims the benefit of U.S. Provisional Application No. 60/993,759, filed Sep. 14, 2007.

### FIELD OF THE DISCLOSURE

The present disclosure relates to motion compensation systems, and more particularly to a heave compensation system for a crane mounted on a vessel to isolate the load being raised or lowered by the crane from the vertical movement or heave of the vessel.

### BACKGROUND

Heave compensation in marine vessels has historically been carried out by either an active heave compensation system or a passive heave compensation system, or a combination of the two systems. An active heave compensation system relies on motion reference sensors that are mounted on the deck of the vessel to measure the amount of heave. The correction of motion due to the heave of the vessel is accomplished by movement of a hydraulic cylinder that drives a multi-wire rope sheave assembly through the output signals derived from the motion reference unit sensors.

A limitation of active heave compensation systems is that the heave displacement correction is limited by the hydraulic cylinder stroke. In order to compensation for significant levels of heave, very large hydraulic cylinders are required resulting in significant weight as well as significant associated components of the system. Also, an active heave compensation system cannot sense the level of frequency of the load being experienced by the load-carrying line. Thus, it is possible to have the same natural frequency of the vessel as well as the load during lowering, which can lead to catastrophic results.

A passive heave compensation system typically relies on the compression of a compensating cylinder. During the heave of a vessel, the compensating cylinder has one end connected to the vessel and the other (rod) end connected to the load-carrying line. As the vessel heaves, the piston in the cylinder moves up and down to compensate for the heave. The pressure within the cylinder is adjusted to a correct level using gas-filled accumulators. As would be appreciated, the cylinder pressure must change with different load levels being handled. The drawback of passive heave compensation systems is that their response time may be relatively slow and thus not capable of “keeping up” with the heaving action in rough seas.

Thus, a heave compensation system that can overcome the drawbacks of existing active and passive compensation systems, while still being of relatively simple and straightforward design, could be greatly beneficial.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A heave compensation system for a lift mechanism mounted on a floating vessel, with the vessel subject to periodic and transient short-term vertical movements. The lift mechanism includes a boom having a proximal end at the vessel and a distal end extendable beyond the vessel. A load line extends along the boom and is supported by the boom. The load line has a distal end connectable to a load and a proximal end engageable with the winch carried by the vessel. The winch is powered to pay out the load line and to reel in the load line. A heave compensation system comprises an accelerometer mounted on a distal end of the boom to sense the vertical movement of the distal end of the boom and transmit signals related to such movement. A winch control system controls the operation of the winch. A heave compensation control system receives signals from the accelerometer and converts such signals into control signals that are transmitted to the winch control system to cause the winch control system to control the operation of the winch to compensate for the heave being experienced by the vessel.

In accordance with a further aspect of the present invention, the winch control system controls the speed that the winch pays out the load line and reels in the load line.

In a further aspect of the present invention, the heave compensation control system converts signals from the accelerometer into control signals transmitted to the winch control system to cause the winch control system to control the direction and speed of operation of the winch to compensate for the heave being experienced by the vessel.

In another aspect of the present invention, a harmonic load control subsystem detects the occurrence of a harmonic load condition on the load line and adjusts the speed of operation of the winch to eliminate such harmonic load condition on the load line.

In another aspect of the present invention, the harmonic load control subsystem detects the load on the load line as a function of time and adjusts the speed of operation of the winch if a harmonic load condition is detected. The means for detecting the load on the load line may include transducers incorporated into the winch.

In another aspect of the present invention, the lift mechanism includes a crane mountable on a floating vessel. The crane has a boom with a proximal end mountable to the vessel and a distal end deployable beyond the vessel. A powered winch is carried by the crane and a load line extends from the winch along the boom to a distal end that is connectable to a load. A motion sensor is mounted on a distal end of the boom to sense the vertical movement of the distal end of the boom and transmit signals relative to such movement. A winch control system controls the operation of the winch. A heave compensation control system receives signals from the motion sensor and converts such signals into control signals to cause the winch control system to control the operation of the winch to compensate for the heave being experienced by the vessel.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial view of a crane utilizing a motion/heave compensation system of the present disclosure;

FIG. 2 is a view similar to FIG. 1 with the crane shown in a different position and with the location of the components of the heave compensation system illustrated;

FIG. 3 is a schematic view showing the movement of the crane of FIGS. 2 and 3;

FIG. 4 is a schematic view of the motion compensation system of the present disclosure;

FIG. 5 is a view similar to FIG. 4, but showing the hydraulic supply in more detail; and

FIG. 6 is a schematic of the hydraulic system for the crane.

### DETAILED DESCRIPTION

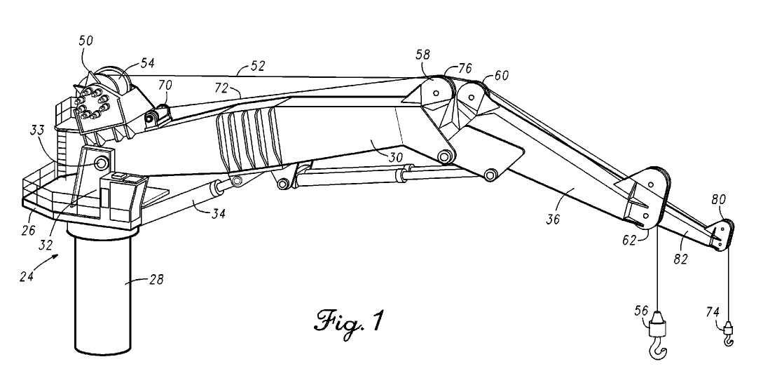

Referring to the drawings, and in particular FIGS. 1-3, a lift mechanism in the form of a crane 20 is mounted on a vessel or ship 22. The crane 20 has a base structure 24 composed of a base platform 26 mounted on the upper end of a rotatable pedestal 28 that is receivable within the corresponding structure on the ship 22. The pedestal allows the crane to be rotated about the pedestal by a rotational drive system that can be of a standard construction.

The crane 20 further includes a lower arm 30 having a lower end pivotally mounted on spaced-apart mounting ears 32 extending upwardly from base 24. A cross pin 33 is carried by the mounting ears 32, and engages through a cross hole formed in the lower end portion of arm 30. The arm 30 can be raised and lowered by actuation of fluid linear actuators that may be in the form of hydraulic cylinders 34 having their lower ends pinned to base 24 and their upper ends pinned to an intermediate location along the length of the arm.

The crane 20 also includes an upper arm 36 having a lower end portion pinned to the upper end portion of the lower arm 30. The upper arm 36 is pivotally connected relative to the lower arm 30 by linear actuators that may be in the form of fluid 38 having lower end portions pivotally pinned to an intermediate location along the lower arm 30 and upper end portions pivotally pinned to an intermediate location along the length of the upper arm 36.

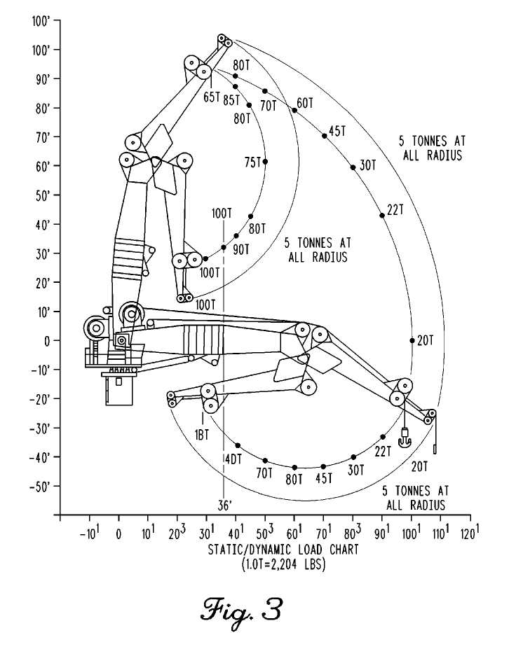

Operation of the linear actuators 34 and 38 enables the crane 20 to be raised and lowered as well as to be extended and retracted. In this regard, see FIG. 3 for the range of motion of the crane.

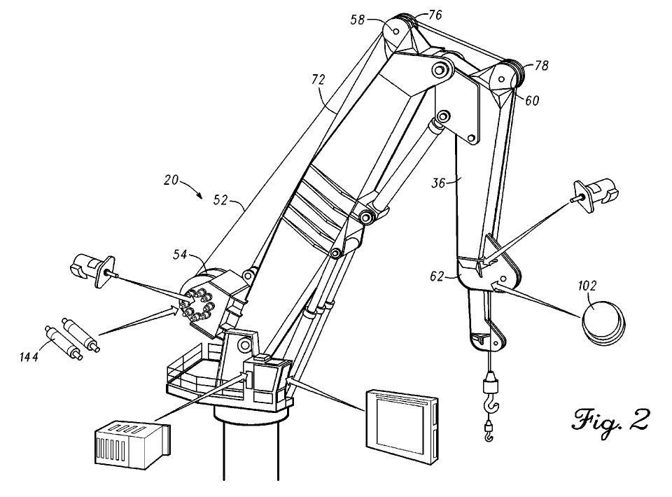

Referring specifically to FIGS. 1 and 2, a main load winch 50 is mounted on the lower end portion of arm 30 to pay out or reel in a main load wire rope cable or other type of line 52 which is wound about a spool 54. A hook 56 is attached to the distal end of line 52. Between spool 54 and hook 56, the line 52 extends over a guide sheave 58 mounted on the distal end of arm 30, a further guide sheave 60 mounted on the lower or proximal end of arm 36, and a distal sheave 62 mounted on the distal end portion of arm 36.

Crane 20 further includes an auxiliary winch 70 also mounted on the lower or proximal end of arm 36 used to pay out or reel in auxiliary line or cable 72 which extends along the length of arm 30 and arm 36 to carry at its distal end a hook 74. As in cable 52, cable 72 is also guided by a sheave 76 adjacent sheave 58, a sheave 78 adjacent sheave 60, and a sheave 80 located at the distal end of an arm extension portion 82 extending beyond sheave 62.

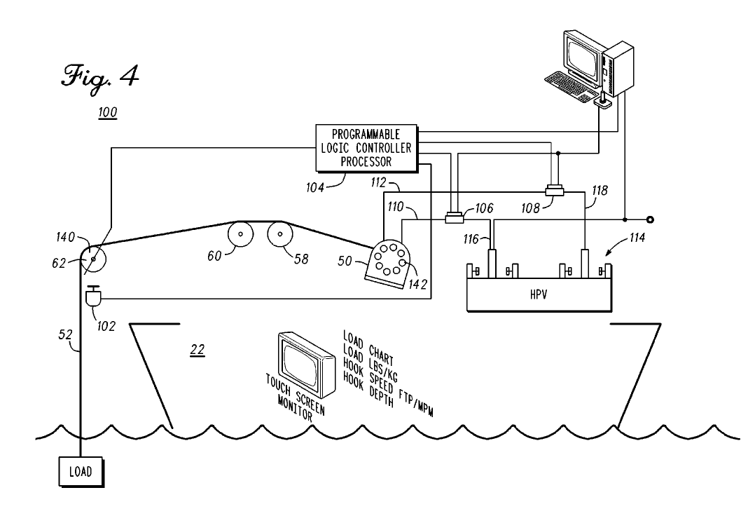

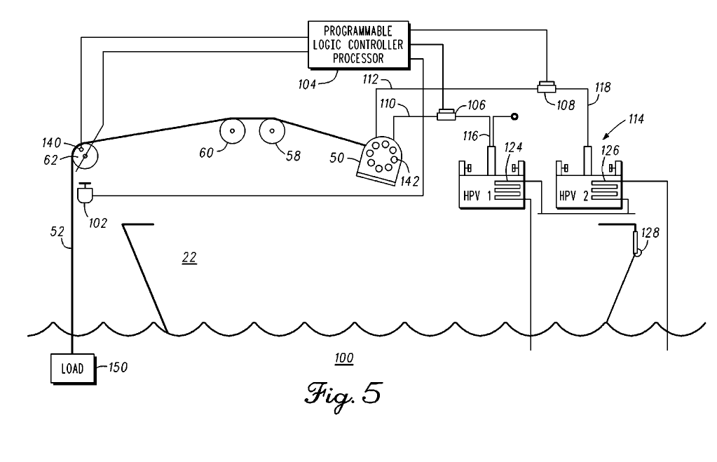

Referring additional to FIGS. 4 and 5, a heave or motion compensation system 100 is employed on crane 20 to compensate for the heave experienced by ship 22 during operation of the crane. The heave compensation system includes a motion reference unit 102 in the form of an accelerometer mounted on the distal end portion of crane arm 36. The accelerometer 102 measures the movement (acceleration) of the distal end of arm 36. This information is transmitted to a microprocessor in the form of a programmable logic control processor 104. The control processor 104 controls a winch control system that, in turn, controls the operation of the winch. The winch control system includes electric control valves 106 and 108 that control the flow of hydraulic fluid or other fluid medium to winch 50, thereby operating the direction of rotation of the winch spool 54 as well as the speed of rotation of the spool.

Accelerometers such as accelerometer 102 are articles of commerce. Suitable accelerometers for use with motion compensation system 100 are used in the aerospace industry.

Hydraulic fluid flows from control valve 106 to winch 50 through line 110, whereas hydraulic fluid flows from control valve 108 to winch 50 through line 112. It will be appreciated that if hydraulic fluid is flowing to winch 50 through line 112, the fluid is also simultaneously flowing from winch 50 through line 110, and vice versa. Hydraulic fluid flows from valve 106 to hydraulic supply 114 through line 116, whereas hydraulic fluid flows between valve 108 and supply 114 through line 118.

The hydraulic fluid is illustrated in FIG. 5 as stored in separate reservoirs 120 and 122 for lines 116 and 118, respectively. However, the hydraulic fluid could be instead stored in a single reservoir. The hydraulic fluid in reservoirs 120 and 122 is cooled using ambient water that is pumped through heat transfer devices 124 and 126 in reservoirs 120 and 122 via cooling water pump 128.

The motion compensating system 100 also includes an encoder 140 mounted on the distal end of boom arm 36 to measure the rotation of sheave 62, and thus the position and movement of line 52. A second encoder 142 is mounted on winch 50 to monitor and measure the rotation of spool 54, and thus the speed of movement and extent of pay out or reeling in of line 52. This information is transmitted to the logic control processor 104.

The control processor 104, as noted above, receives signals from the accelerometer 102, which signals are related to the movement at the distal end of the crane arm 36. Such movement is due to the heave being experienced by the vessel as well as the movement of the crane arm. The information from the encoders 140 and 142 is also transmitted to the control processor 104. With this information, the control processor controls and detects the payout of the load line 52 as well as the payin of the line and the speed thereof. Such payout and payin is coordinated with the heave being experienced by the vessel as well as the operation of the crane itself.

Moreover, the control processor can be programmed to recognize a trend in the amplitude and frequency of the heave being experienced by the vessel, thereby enabling the motion compensating system of the present disclosure to better compensate for such heave. In essence, the control processor 104 is able to model the “shape” of the heave, which may be in the form of a sine wave or other wave form.

The motion compensation system 100 of the present disclosure also includes pressure transducers 144 incorporated into the winch 50 to detect the load on the line 52. Such pressure transducers measure the hydraulic pressure at an applicable location in the winch that operates hydraulically. If the winch was electrically operated, suitable transducers could be incorporated into the drive system or drive mechanism of the winch.

As is not uncommon, when a load, such as load 150, shown in FIG. 4, is attached to the end of line 52 and is being lowered or raised, the heave being experienced by the vessel 22 can result in harmonic loads being imposed on the line 52. If a resonance condition in the line were to develop, the resulting stress imposed on the line could lead to failure of the line. Thus, the transducers 144 are utilized to measure the load on the line 52 over time.

In operation, the heave compensation system 100 measures the vertical movement of the distal end of the crane boom not only due to heave, but also due to the operation of the crane itself, by the use of the accelerometer 102. Signals corresponding to such movement is transmitted to the controller processor 104. The controller processor 104 processes this information and determines what adjustments must be made in the pay out or reeling in of line 52 to compensate for the heave and other movement being experienced at the distal end of the crane. In this regard, the controller processor operates electric control valves 106 and 108 to control the direction of rotation of the winch spool 54 as well as the speed of such rotation. In this manner, the correction of the operation of the crane due to heave of the vessel 22 is accomplished by use of the crane winch 50, rather than requiring other additional heave-compensating apparatus or equipment, as is typical. As such, heave compensation through the present disclosure is accomplished in a more straightforward manner not requiring additional complicated or expensive apparatus or equipment.

Also, the motion compensating system of the present disclosure, as noted above, is able to detect oscillating load levels in the line 52, including whether a resonance situation is developing. If so, the motion compensation system can adjust the speed of the movement of the spool 54 and thereby eliminate the development of a resonance condition. For example, applicants have found that changing the speed of the movement of line 52 by as little as 15% can eliminate a resonance condition in the line.

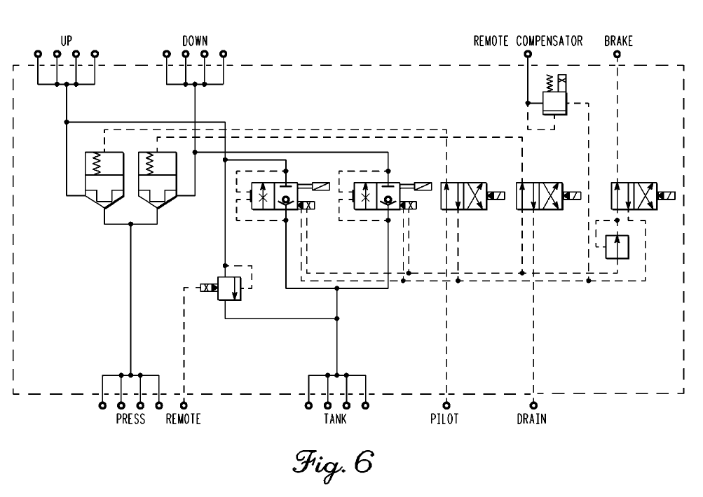

FIG. 6 illustrates a hydraulic schematic for crane 20.

While illustrative embodiments have been illustrated and described, it will be appreciated that various changes can be made therein without departing from the spirit and scope of the invention.

The embodiments of the invention in which an exclusive property or privilege is claimed are defined as follows:

1. A heave compensation system for a lift mechanism mounted on a floating vessel that is subject to periodic and transient short-term vertical movements, the lift mechanism including a boom having a proximal end at the vessel and a distal end extendable beyond the vessel, a load line extending along the boom and supported by the boom, the load line having a distal end connectable to a load and a proximal end engageable with a winch carried by the vessel, the winch powered to pay out the load line and reel in the load line, said heave compensation system comprising:
(a) an accelerometer mounted on the distal end of the boom to sense the vertical movement of the distal end of the boom and transmit signals relative to such movement;
(b) a winch control system to control the operation of the winch; and
(c) a heave compensation control system to receive the signals from the accelerometer and convert such signals into control signals transmitted to the winch control system to cause the winch control system to control the operation of the winch to compensate for the heave being experienced by the vessel.

2. The heave compensation system of claim 1, wherein the winch control system controls the speed that the winch pays out a load line and reels in the load line.

3. The heave compensation system of claim 2, wherein the heave compensation control system converts signals from the accelerometer into control signals transmitted to the winch control system to cause the winch control system to control the direction and speed of operation of the winch to compensate for the heave being experienced by the vessel.

4. The heave compensation system of claim 1, wherein the winch control system controls the flow of hydraulic fluid to and from the winch.

5. The heave compensation system of claim 1, wherein the heave compensation control system further comprising a harmonic load control subsystem comprising means to detect the occurrence of harmonic loads in a load line of a boom and adjust the speed of operation of a winch to eliminate such harmonic load condition in the load line.

6. The heave compensation system of claim 5, wherein the harmonic load control subsystem comprising means for detecting the load on the load line as a function of time and means for adjusting the speed of operation of a winch to eliminate the harmonic load condition on the load line.

7. The heave compensation system of claim 6, wherein the means for detecting the load on the load line comprises transducers incorporated into the winch.

8. The heave compensation system of claim 7, wherein the winch is hydraulically powered and the detecting means comprising hydraulic fluid pressure transducers.

9. A heave compensation system for a crane mounted on a floating vessel that is subject to wave action, the crane includes a boom having a proximal end at the vessel and a distal end deployable beyond the vessel, a winch carried by the crane, and a load line extending from the winch and along the boom to a distal end connectable to a load, said heave compensation system comprising:
a. instrumentation at the distal end of the boom to measure the vertical movement of the distal end of the boom and transmit signals relative to such vertical movement;
b. a winch control system to control the direction and speed of operation of the winch; and
c. a heave compensation control system to receive signals from the instrumentation at the distal end of the boom and convert such signals into winch control signals to control the operation of the winch to cause the winch to compensate for the heave being experienced by the vessel.

10. The heave compensation system of claim 9, wherein the winch control system controls the speed that a winch pays out a load line and reels in the load line.

11. The heave compensation system of claim 10, wherein the heave compensation control system converts signals from the instrumentation to control signals transmitted to the winch control system to cause the winch control system to control the direction and speed of operation of the winch to compensate for the heave being experienced by the vessel.

12. The heave compensation system of claim 9, wherein the winch control system controls the flow of hydraulic fluid to and from the winch.

13. The heave compensation system of claim 9, wherein the heave compensation control system further comprising a harmonic load control subsystem, comprising means to detect the occurrence of harmonic loads on a load line of a crane and adjust the speed of operation of a winch to eliminate such harmonic load condition in the load line.

14. The heave compensation system of claim 13, wherein the harmonic load control subsystem comprising means for detecting the load on the line as a function of time and means for adjusting the speed of operation of a winch to eliminate the harmonic load condition on the load line.

15. A heave compensation system according to claim 14, wherein the means for detecting the load on a load line comprises transducers incorporated into the winch.

16. A heave compensation system according to claim 15, wherein the winch is hydraulically powered and the detecting means comprising hydraulic fluid pressure transducers.

17. A heave compensated crane mountable on a floating vessel that is subject to periodic and transient short-term vertical movements, said crane comprising:
a. a boom having a proximal end mountable to a vessel and a distal end deployable beyond a vessel;
b. a powered winch carried by the crane;
c. a load line extending from the winch along the boom, the load line having a distal end connectable to a load;
d. a motion sensor mounted on the distal end of the boom to sense the vertical movement of the distal end of the boom and transmit signals relative to such movement;
e. a winch control system to control the operation of the winch; and
f. a heave compensation control system to receive signals from the motion sensor and converts such signals into control signals to cause the winch control system to control the operation of the winch to compensate for the heave being experienced by the vessel.

18. The heave compensated crane according to claim 17, further comprising a harmonic load control subsystem to detect the occurrence of harmonic loads on the load line and adjust the speed of operation of the winch to eliminate such harmonic load condition on the load line, said harmonic load control subsystem comprising means for detecting the load on the load line as a function of time and adjusting the speed of operation of the winch based on the reduction of a harmonic load condition on the load line.
